(19) United States
(12) Patent Application Publication
(10) Pub. No.: US 2012/0156462 A1
(43) Pub. Date: Jun. 21, 2012

(54) ULTRAVIOLET PROTECTIVE FABRICS BASED ON MAN-MADE CELLULOSIC FIBERS

(75) Inventors: Clemens Bisjak, Zipf (AT); Andreas Gürtler, Weyregg (AT); Peter Dobson, Derby (GB); Karin Kämpf, Eberschwang (AT); Christian Schuster, Vocklabruck (AT); Gert Kroner, Lenzing (AT)

(73) Assignee: LENZING AG, Lenzing (AT)

(21) Appl. No.: 13/378,015

(22) PCT Filed: May 3, 2010
(86) PCT No.: PCT/AT2010/000142

§ 371 Date: Mar. 12, 2012

(30) Foreign Application Priority Data
Jun. 15, 2009 (AT) A 911/2009

(51) Int. Cl. B32B 23/02; D04B 1/24; B32B 5/02

(52) U.S. Cl. 428/219; 442/131; 442/60; 28/153

(57) ABSTRACT

The present invention relates to UV protective fabrics, whereupon these fabrics are made of UV protective cellulosic fibers, namely manufactured by the Modal or the Lyocell process. Besides the permanent and inherent protection against UV rays of the named fiber materials and thus fabrics, UV protection is still guaranteed, when the fabrics are wet and stretched. As a result of fiber swelling, the fabric construction becomes denser and as a direct result, UV transmission is significantly reduced compared to the dry and stretched state.

### BACKGROUND OF THE INVENTION

1. Field of the Invention

The present invention relates to ultraviolet (UV) protective fabrics, whereupon these fabrics are made of UV protective high-tenacity man-made cellulosic fibers. Besides the permanent and inherent protection against UV rays of the named fiber materials and thus fabrics, UV protection is still guaranteed, when the fabrics are wet and stretched. As a result of fiber swelling, the fabric construction becomes denser and as a direct result, UV transmission is significantly reduced compared to the dry and stretched state.

2. Background of the Invention

Awareness of the effects and consequences of excessive exposure to UV radiation have led to an increased research interest concerning protection against UV rays. UV exposure, especially to UVA (380-315 nm) and UVB (315-280 nm) radiation, is known to cause damage of the skin like sunburn, skin-aging, allergies and even skin cancer. Dermatologists warn that particularly children should be protected from long periods of incident solar radiation, e.g. with sun protective textiles. Also for sportsmen and people, who occupationally have to remain outdoors, sun protection is vital.

In comparison to sun cream, textile materials allow for permanent protection from UV rays. However, it is hardly possible to quantify the UV shielding of textile materials by close evaluation. Well-defined standard methods, based on the determination of the Ultraviolet Protection Factor (UPF) are used in order to classify textiles according to their UV protection ability. The named standards include UV Standard 801, AS/NZS 4399:1996 and EN 13758-1. Generally speaking, sun-protective clothing must exhibit UPF values of 15 (good) to 50+ (excellent) in order to provide satisfying sun protection properties. This means that sun protective clothing has to exhibit a minimum UPF of 15 in order to be classified as sun protective. For the purposes of the present invention the AS/NZS 4399:1996 Sun Protective Clothing Evaluation and Classification Standard is used as the standard.

The UPF of fabrics varies significantly, depending on several parameters, namely fiber type, color of the fiber and thus yarn material, constructional parameters (thickness, density, weave and yarn type, mass per unit area), presence of additives (pigments, optical brightening agents) as well as mechanical parameters (elasticity), aftertreatments, washing, laundering and moisture content. However, fabric porosity is known to be the parameter that influences UV protection most, as it determines UV transmission. Therefore, this is the key point to focus on when developing light-weight summer fabrics for beach or sports wear.

In general, high-weight, dark-colored and thick fabrics absorb a higher amount of UV rays than light-weight, light-colored and thin fabrics. This fact represents a severe limitation regarding the manufacture of summer clothing, since summer garments are, by definition, represented by light-weight constructions. But the most intense UV radiation is observed in summer season. So the potential of skin damage (sun burn, skin cancer), in what ever form, therefore is the highest in summer. The objective regarding UV protection, especially for beach and sports wear and even for light-weight summer work wear therefore has to be the creation of light-weight, light-colored fabrics, which are comfortable to wear in hot season and additionally offer an optimum UV shielding ability under almost all occurring wear conditions.

Determination of the UPF of an unstretched, dry fabric sample can lead to significant misinterpretation regarding its UV protection properties, as the UPF is known to decrease under wearing conditions as a result of stretching and wetting. While stretching occurs due to the various movements of the wearer during activities, wetting may occur either by contact with water during swimming, sailing, surfing, fishing or other water sports but also simply by sweating during hiking, running, cycling, climbing, all other outdoor sports like tennis, beach volleyball etc. or even working. For example a commonly used sports wear fabric, e. g. for T-shirts, is a 170 g/m² single jersey, made of 100% undyed, i. e. white cotton. In the dry state, this fabric shows a UPF of 11, measured according to AS/NZS 4399:1996. If it is stretched in the dry state according to UV Standard 801 the UPF reduces to 5.

Generally, known fabrics offer significantly lower protection from UV radiation when wet due to higher transparency. The drop in levels of protection depends on the type of fiber/fabric and the amount of moisture it absorbs. E. g. the UPF of the cotton fabric described above is 7 if wetted and stretched according to UV Standard 801. The slight increase of the UPF in the stretched state after wetting may be the effect of a swelling of the fiber.

There are several other approaches to create UV-blocking textile materials besides variation of typical construction parameters. One possible way is to treat fibers or fabrics with a UV-blocking finish, which usually contains e.g. organic UV-blocking substances or inorganic particles. But such finishes are known to lack durability. They will be removed at least partly from the fabrics during use and washing due to abrasion, leaching and the like, resulting in a loss of their UV-blocking properties.

A method commonly known in the polymer industry to overcome this disadvantage is the incorporation of functional substances into the molded bodies during the molding process by adding the substances to the mass before molding, e. g. into the polymer melt or solution. Of course this method cannot be applied to the naturally grown cotton fiber.

It is known for polyester fibers to enhance the UV-blocking properties durably by incorporation of pigments during the spinning process which possess the ability to reduce transmission over the whole UV range. The utilized pigments can be of organic or inorganic origin. Since organic pigments are known to negatively affect the physical properties of the fibers to a higher extent than their inorganic counterparts, inorganic pigments such as titanium dioxide or zinc oxide, are more frequently used to affect the UV absorption and reflection properties of fiber materials. In comparison to the cotton fabric described above a fabric showing the same construction (170 g/m² single jersey) but consisting of 100% UV-blocking polyester fibers shows a nearly doubled UPF value of 20 in the dry, unstretched state. But after stretching in the dry state the UPF decreases to 8. A slight increase in UPF up to 12 can be recognized if the fabric is stretched in the wet state. As polyester does not swell with water, the water will be only adsorbed on the fiber surface and the slightly increased UPF therefore may be caused by reflection of the UV or similar effects. But in summary even such a fabric will not fulfill the requirements of a UPF of at least 15 under realistic wear conditions. Additionally fabrics made of synthetic fibers like polyester or nylon provide a very low wear comfort and bad body climate due to their low moisture absorption ability.

The incorporation of particles into man-made cellulosic fibers is already known. For example DE 195 42 533 discloses the incorporation of ceramic particles into Lyocell for the manufacture of sensor fibers. No certain compositions for these particles are mentioned. WO 2003/024891 discloses the incorporation of high amounts of TiO₂ into Lyocell for the manufacture of precursors for ceramic fibers but these precursors have completely different properties than fibers for the use in light-weight textiles. WO 96/27638 discloses the use of a masterbatch containing up to 50% (w/w) TiO₂ in a Lyocell process for fibers for several applications, but is completely silent about the particle size and distribution of the particles as well as of the particle content in the final fibers required for light-weight UV-protective fabrics.

In view of this state of the art it is an object of this invention to provide an improved UV protection fabric, particularly for textile use as beach or sports wear or summer work wear which shows an improved UPF sufficient to protect the wearer under realistic wear conditions, as well as a good wear comfort and body climate and a tear strength sufficient to resist the rough conditions which normally occur during outdoor sports activities as well as during working.

In particular it is an object of this invention to provide an improved, durable UV protection fabric, which remains its UV shielding ability when wet and being in stretched state so that it can be used as beach wear, sports wear and even outdoor work wear for summer or other warm conditions.

### SUMMARY OF THE INVENTION

The solution to this problem is a UV-protective fabric, containing high-tenacity man-made cellulosic fibers which contain incorporated inorganic nano-scale pigments. For the purposes of this invention a nano-scale pigment shall be characterized by an x₅₀-value of lower than 1000 nm. Incorporated pigments shall be pigments which are added to the cellulose solution prior to spinning Such incorporation regularly results in a very even distribution of the pigments in the fibers. This can be evaluated easily, for example by simple light microscopy of the cross-section of the fibers.

Fibers in the context of the present invention are mainly staple fibers. But also fabrics containing endless filaments will be within the scope of the invention as long as the relevant properties as outlined below are met, because filaments will generally show the same behavior in terms of effect of the pigment, the swelling, the moisture management, mechanical strength etc.

### BRIEF DESCRIPTION OF THE DRAWINGS

For a more complete understanding of the present invention, and the advantages thereof, reference is made to the following descriptions taken in conjunction with the accompanying figures, in which

FIGS. 1 & 2 are graphs showing the effect of wetness on the UPF of light-weight knitted fabrics.

### DETAILED DESCRIPTION OF THE INVENTION

High-tenacity man-made cellulosic fibers according to the present invention shall be man-made cellulosic fibers with a tenacity at break of at least 30 cN/tex in the conditioned state and at least 18 cN/tex in the wet state, both parameters evaluated according to BISFA.

Preferably in this fabric the cellulosic fibers contain between 0.1 and 1.5% (w/w) of an incorporated nano-scale TiO₂ pigment with a particle distribution characterized by an x₅₀ lower than 1000 nm and x₉₉ lower than 2000 nm. Most preferably the pigment is TiO₂ as it is commercially available in sufficient quantities and quality. All particle distribution values described in the context of the present invention were measured with a HELOS/BF particle size analyzer with laser diffraction and installed software.

In a particular embodiment of the invention the fabric additionally contains at least one type of synthetic fiber and/or natural cellulose fiber. The synthetic fiber can be made of polyester, polyamide, polyimide, aramide or any other suitable synthetic material and may have any denier suitable for the fabric types mentioned herein. One special type of synthetic fiber to be mentioned here additionally is Elastan which is often mixed with other fibers for the use in beach wear, sports wear and the like. The natural cellulose fiber will be mainly cotton, but can also be any other natural cellulose fiber like linen or hemp. The blending of different fiber types is common in the textile industry for different reasons. But for the objects of the present invention there are certain requirements to be achieved: E. g. blends of the high-tenacity man-made cellulosic fibers containing incorporated inorganic nano-scale pigments with polyester result in light-weight constructions with high fabric strength at an economic price. The amount of polyester present in the fabric also can be used to regulate the moisture uptake of the fabric, which may be different for different applications. Blends of the high-tenacity man-made cellulosic fibers containing incorporated inorganic nano-scale pigments with cotton fibers will result in economic fabrics with high wear comfort. Such blends can be made by mixing the fibers before making the yarn or they can be made by mixing pure yarns in warp and weft. For example a blend of 50% of the cellulosic fibers according to the invention with 50% of Coolmax® polyester fiber can be used for many applications in the field of beach wear and sports wear.

By incorporating UV-protective particles into the cellulosic fibers the strength of the fibers is decreased significantly. Therefore special manufacturing processes have to be used to obtain fibers with the required mechanical properties. One especially preferred embodiment of the invention therefore is a fabric, wherein the high-tenacity man-made cellulosic fibers are Lyocell fibers. Lyocell fibers according to the BISFA definition are cellulosic fibers obtained by an organic solvent spinning process, wherein it is understood that an “organic solvent” means essentially a mixture of organic chemicals and water, and “solvent spinning” means dissolving and spinning without the formation of a derivative. Such processes are well-known from the literature of the last 20 years. These fibers not only show a remarkably high tenacity in the conditioned state, but also in the wet state despite their content of incorporated pigments. Another surprising advantage of the use of Lyocell fibers is that these fibers tend to fibrillate and that such fibrillation gives an additional increase in UPF. A woven Lyocell fabric made from fibers with incorporated inorganic nano-scale pigments which was fibrillated after the weaving showed a nearly doubled UPF compared to a similar fabric which was resin treated and defibrillated after weaving. This is an important advantage especially in comparison to fibers with a UV-protective finish, where no fibrils of UV-protective material occur.

Another preferred embodiment is a fabric, wherein the high-tenacity man-made cellulosic fibers are Modal fibers, i. e. fibers manufactured according to a modified viscose process, for example described in the Austrian patent publication AT 287905. These fibers also show a remarkably high tenacity in the conditioned as well as in the wet state despite their performance in some aspects is lower than that of a Lyocell UV-protective fiber. Fibers manufactured according to a standard viscose process with incorporation of UV-protective particles will never reach the required mechanical properties, especially not in the wet state.

According to the field of the invention the high-tenacity man-made cellulosic fibers in this fabric show a fineness of 0.8 to 3.3 dtex, preferably 0.9 to 1.7 dtex. Fibers with a higher fineness will not show sufficient mechanical properties due to the influence of the UV-protective particles. Fibers with a lower fineness, i. e. larger diameter, will not be suitable for the soft, light-weight fabrics. Mostly the fabrics are knitted or woven fabrics. Such fabrics preferably have a mass per unit area of 120 to 270 g/m². Lighter fabrics will not show a sufficient UPF even when made of 100% incorporated fibers according to the invention. For heavier fabrics an acceptable UPF can be reached by standard fibers without incorporated inorganic nano-scale pigments.

Another object of the present invention is the use of high-tenacity man-made cellulosic fibers containing incorporated inorganic nano-scale pigments for the manufacture of an UV-protective fabric for light-weight beach, sports or work wear. The fibers can be used according to the descriptions as outlined above.

Yet another object of the present invention is a method for improving the UV protection of light-weight beach, sports or work wear by using a fabric containing a blend of high-tenacity man-made cellulosic fibers which contain incorporated inorganic nano-scale pigments with non-pigmented fibers in a ratio according to the following general rules: The higher the mass per unit area of the fabric, the lower the TiO₂-content can be. But at a mass per unit area of more than 270 g/m² the use of fibers with 1% or more of TiO₂ will no further be reasonable. With regard to fiber blends the amount of UV-protective fiber has to be increased with decreasing mass per unit area. To maintain a high tear resistance of such a thin fabric, especially in the wet state, the UV-protective cellulosic fiber has to show a high tenacity. For fabrics with a very “open” construction the amount of UV-protective fiber has to be increased, too to keep a high UPF value.

The invention will now be illustrated by examples. These examples are not limiting the scope of the invention in any way.

### Example 1

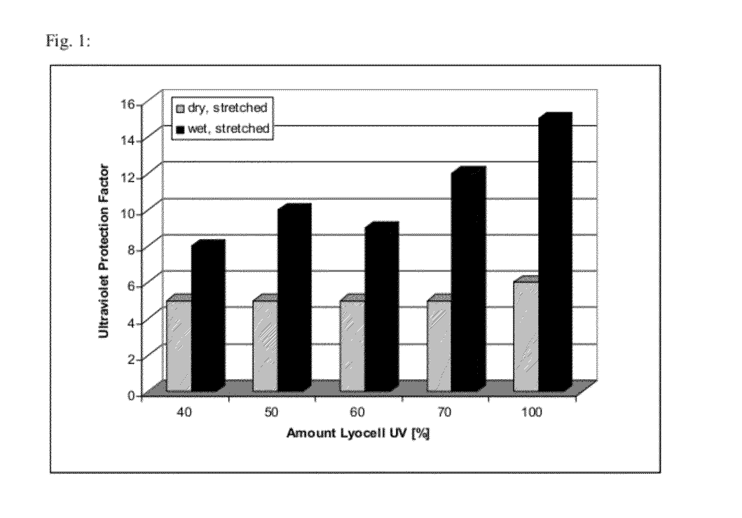

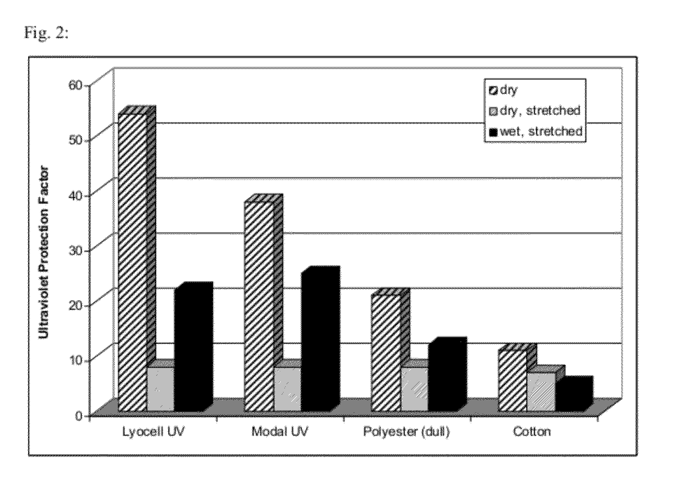

1.3 dtex UV-protective Lyocell fibers with a staple length of 38 mm were manufactured according to the Lyocell process by incorporating 1% (weight/weight) of TiO₂ (commercially available Kronos 2064) using a suitable dispersing agent. The TiO₂ dispersion was filtered before adding it to the Lyocell dope. In the filtered dispersion the TiO₂ showed a particle size distribution characterized by an x₅₀ of 570 nm and an x₉₉ of 1160 nm. The fibers show a tenacity (cond.) of 33.0 cN/tex and a tenacity (wet) of 25.5 cN/tex. The elongation at break (wet) was 14.5%. In order to demonstrate the effect of wetness on the UPF of light-weight knitted fabrics when using single jersey fabrics made of these fibers, a series of blends of these fibers with cotton were ring-spun into Nm50 yarns and therefrom single jersey fabrics, having a mass per unit area of 140 g/m², were fabricated. The fabrics were made wet and stretched, using a biaxial stretching frame according to UV Standard 801. Subsequently the UPF was determined according to the AS/NZS 4399:1996 Sun Protective Clothing Evaluation and Classification Standard. The obtained results are summarized in FIG. 1. It can clearly be deduced that the higher the amount of UV-protective Lyocell in the fiber blend, the higher the UPF in the wet and stretched state. For fabrics, consisting of 70% (or even higher) UV-protective Lyocell, the UPF was found to be more than doubled when comparing the dry and the wet stretched samples.

### Example 2

1.3 dtex UV-protective Modal fibers with a staple length of 39 mm were manufactured according to the process described in the Austrian patent publication AT 287905 by incorporating 1% (weight/weight) of TiO₂ (commercially available Kronos 2064) using a suitable dispersing agent. The TiO₂ dispersion was filtered before adding it to the spinning dope. In the filtered dispersion the TiO₂ showed a particle size distribution characterized by an x₅₀ of 570 nm and an x₉₉ of 1160 nm. The fibers show a tenacity (cond.) of 34.0 cN/tex and a tenacity (wet) of 19.0 cN/tex. The elongation at break (wet) was 15.0%. For further demonstration of how the fiber swelling positively affects UV protection, these UV-protective Modal fibers as well as the UV-protective Lyocell fibers of example 1, were ring-spun into Nm50 yarns and therefrom single jersey fabrics having a mass per unit area of 170 g/m², were fabricated. Before evaluation of their UV protection ability, the fabrics were wetted and stretched according to UV Standard 801. Subsequently the UPF was determined according to the AS/NZS 4399:1996 Sun Protective Clothing Evaluation and Classification Standard. A summary of the obtained results is given in FIG. 2. As expected, wetting the fabrics had a significant effect on UPF values, greatly depending on the nature of fiber. The UPF values for UV-protective Modal and UV-protective Lyocell fabrics increased in the wet state, which is in accordance with the previous findings described in Example 1. It is clearly demonstrated that UV-protective Modal or UV-protective Lyocell retain their UV protection ability also in the wet state, which is confirmed by UPF values of 20 and higher. FIG. 2 also shows the less performing results for 170 g/m² single jersey fabrics made of regular cotton and of commercially available 1.3 dtex polyethylene terephthalate fibers containing 1% (w/w) of TiO₂.

Summarizing these results it can be concluded that the swelling potential of UV-protective Modal or UV-protective Lyocell fibers represents a remarkable benefit when designing UV protective clothing for beach wear, sports wear and even work wear.

1. An ultraviolet-protective fabric, comprising high-tenacity man-made cellulosic fibers which contain incorporated inorganic nano-scale pigments.

2. The fabric according to claim 1, wherein the cellulosic fibers contain between 0.1 and 1.5% (w/w) of an incorporated nano-scale TiO₂ pigment with a particle distribution having an x₅₀ lower than 1000 nm and x₉₉ lower than 2000 nm.

3. The fabric according to claim 1, wherein the fabric additionally comprises at least one type of fiber selected from the group consisting of synthetic fiber, cellulose fiber and mixtures thereof.

4. The fabric according to claim 1, wherein the high-tenacity man-made cellulosic fibers are Lyocell fibers.

5. The fabric according to claim 1, wherein the high-tenacity man-made cellulosic fibers have a fineness of 0.8 to 3.3 dtex.

6. The fabric according to claim 1, wherein the fabric is selected from the group consisting of a knitted fabric and a woven fabric.

7. The fabric according to claim 1, wherein the fabric has a mass per unit area of 120 to 270 g/m².

8. A method of making an ultraviolet-protective fabric for light-weight beach, sports or work wear, comprising providing high-tenacity man-made cellulosic fibers which comprise incorporated inorganic nano-scale pigments.
